(19) United States
(12) Patent Application Publication
(10) Pub. No.: US 2008/0016980 A1
(43) Pub. Date: Jan. 24, 2008

(54) FRAME MOUNTED HANDLEBAR HAVING A DRIVING PIVOT AXIS PERPENDICULAR TO A STEERING AXIS

(76) Inventor: Tomas Raul GUTIERREZ, Edmonton (CA)

Correspondence Address: EDWARD YOO C/O BENNETT JONES, 1000 ATCO CENTRE, 10035 - 105 STREET, EDMONTON, ALBERTA, AB, T5J3T2, US

(21) Appl. No.: 11/458,273

(22) Filed: Jul. 18, 2006

(51) Int. Cl. B62K 21/12

(52) U.S. Cl. 74/551.1

(57) ABSTRACT

A device comprising a handlebar attached to a support frame by drive actuation means comprising a shaft or ratchet mechanism operationally connected to a vehicle drive wheel and by steering actuation means comprising a shaft connected to a vehicle wheel. Reciprocating rotational movement of handle bar about a drive pivot axis actuates the shaft or ratchet mechanism. Reciprocating rotational movement of the handlebar about a steering axis actuates the shaft. The drive pivot axis and the steering axis are substantially perpendicular to each other. In a preferred embodiment the drive actuation means includes a three ratchet type device cassette, one ratchet type device inside one in the opposite direction and two in the parallel direction.

### FIELD OF THE INVENTION

The invention is in the field of operator powered vehicles such as bicycles. In particular the invention relates to unconventional driving and steering means for operator powered vehicles.

### BACKGROUND

There are many means known of providing auxiliary upper arm power to drive a bicycle.

U.S. Pat. No. 5,785,336 to Jang discloses modifications to a bicycle in which the back and forth arm motion of the operator supplies auxiliary power to the rear wheel through the foot pedals. However, the device uses very little of the arm motion range available, is complex in construction and operation, and is disadvantageously steered in a conventional manner.

U.S. Pat. No. 4,685,692 to Fullilove discloses providing auxiliary power to the rear wheel of a bicycle through an arm crank connected to the foot pedals by flexible shaft. However, the device does not allow for more a complete and efficient use of the operator's upper arm and chest, and is disadvantageously steered in a conventional manner.

U.S. Pat. No. 4,417,742 to Intengan discloses providing auxiliary power to the rear wheel of a bicycle through an arm crank connected to the foot pedals by flexible shaft, as well as steering the bicycle with the conventional motion by the operator through flexible shaft to an intermediate linkage. However, the device does not allow for more a complete and efficient use of the operator's upper arm and chest, and is disadvantageously steered in a conventional manner.

In particular, Jang, Fullilove and Intengan all disclose a motion by the operator to provide auxiliary power with the arms and chest that disadvantageously interferes with the motion of steering.

Therefore, there is a need in the art for a means of providing auxiliary power to drive a bicycle in a manner mitigating the difficulties posed by the prior art.

### SUMMARY OF THE INVENTION

The present invention is directed toward a device for driving and steering an operator powered vehicle. In one aspect the invention comprises:
(a) a support frame; and
(b) a handlebar attached to the support frame by drive actuation means and by steering actuation means;
   wherein said drive actuation means comprises a shaft or ratchet mechanism operatively connected to a vehicle drive wheel, wherein reciprocating rotational movement of the handlebar about a drive pivot axis actuates the shaft or ratchet mechanism,
   wherein said steering actuation means comprises a shaft connected to a vehicle wheel, wherein reciprocating rotational movement of the handlebar about a steering axis actuates the shaft,
   wherein the drive pivot axis and the steering axis are substantially perpendicular to each other.

The present invention is also directed towards a drive actuation means for transmitting torque comprising:
(a) an axle, defining an axis about which the axle is rotable, having a left and right end, disposed inside and engaging an inner ratchet member such that the torque from the rotating axle is imparted directly, maintaining the direction of the torque, to the inner ratchet member;
(b) an inner ratchet member rotable about the axle, disposed inside and engaging a middle ratchet member, over-running in counter-clockwise direction, driving in clockwise direction such that torque from inner ratchet member is imparted indirectly, reversing the direction of the torque, to the middle ratchet member;
(c) a middle ratchet member disposed inside a pair of opposing outer ratchet members comprising a right outer ratchet member and a left outer ratchet member, rotable about the axle, over-running in a clock wise direction and driving in the counter clockwise direction;
(d) a right outer ratchet member rotable about the axle, over-running in a clockwise direction and driving in a counter clockwise direction engaging and imparting torque directly, maintaining the direction of the torque, to the inner ratchet member; and
(e) a left outer ratchet member rotable about the axle, over-running in a clockwise direction and driving in a counter clockwise direction engaging and imparting torque directly, maintaining the direction of the torque, to the inner ratchet member.

The present invention is further directed towards a drive actuation means for transmitting torque comprising:
(a) a-support-frame;
(b) a bottom bracket supported on the frame, having an axle defining an axis about which the axle is rotable, having a left and right end;
(c) a right outer ratchet member rotable and disposed about the axle, over-running in a counter clockwise direction and driving in a clockwise direction engaging and imparting torque directly, maintaining the direction of the torque, to the axle; and
(d) a left outer ratchet member rotable and disposed about the axle, over-running in a counter clockwise direction and driving in a clockwise direction engaging and imparting torque directly, maintaining the direction of the torque, to the axle.

In a preferred aspect the device for driving and steering an operator powered vehicle comprises:
(a) a frame;
(b) an axle, supported on the frame, defining an axis about which the axle is rotable, having a left and right end, disposed inside and engaging an inner ratchet member such that the torque from the rotating axle is imparted directly, maintaining the direction of the torque, to the inner ratchet member;
(c) an inner ratchet member rotable about the axle, disposed inside and engaging a middle ratchet member, over-running in counter-clockwise direction, driving in clockwise direction such that torque from inner ratchet member is imparted indirectly, reversing the direction of the torque, to the middle ratchet member;
(d) a middle ratchet member disposed inside a pair of opposing outer ratchet members comprising a right outer ratchet member and a left outer ratchet member, rotable about the axle, over-running in a clock wise direction and driving in the counter clockwise direction;
(e) a right outer ratchet member rotable about the axle, over-running in a clockwise direction and driving in a counter clockwise direction engaging and imparting torque directly, maintaining the direction of the torque, to the inner ratchet member;
(f) a left outer ratchet member rotable about the axle, over-running in a clockwise direction and driving in a counter clockwise direction engaging and imparting torque directly, maintaining the direction of the torque, to the inner ratchet; member
(g) a first and a second auxiliary sprocket supported by the frame; and
(h) single circular chain disposed between and engaging the first auxiliary sprocket and the second auxiliary sprocket defining a left side of the chain and a right side of the chain, the left side of the chain partially wrapping around and directly engaging the left outer ratchet member and the right side of the chain partially wrapping around and directly engaging the right outer ratchet member.

### BRIEF DESCRIPTION OF THE DRAWINGS

The invention will now be described by way of an exemplary embodiment with reference to the accompanying simplified, diagrammatic, not-to-scale drawings. In the drawings:

FIG. 1 is a perspective view of the handlebars mounted in a U-shaped frame actuating a ratchet mechanism;

FIG. 2 is a perspective view of the handle bars mounted in a U-shaped frame in another embodiment actuating a flexible shaft;

FIG. 3 is a side view of the handlebars mounted in a U-shaped frame attached to a bicycle frame having an auxiliary sprocket and chain;

FIG. 4 is a side view of the handlebars mounted in a U-shaped frame attached to a bicycle frame having a bottom bracket cassette and a finite chain circuit and sprockets;

FIG. 5 is an exploded side view of the gearbox;

FIG. 6 is an exploded front view of the auxiliary sprocket;

FIG. 7 is an exploded front view of the foot pedals and rear sprocket (tandem mechanism);

FIG. 8 is a perspective view of the whole power transfer circuit using the bottom bracket cassette device;

FIG. 9 is an enlarged view of the finite chain circuit;

FIG. 10 is a perspective view of the bottom bracket cassette;

FIG. 11 is an exploded perspective view of the bottom bracket cassette disassembled into its three overrunning clutches;

FIG. 12 is a cross section view of the bottom bracket cassette showing its internal layers;

FIG. 13 is a perspective view of the backing-up mechanism;

FIG. 14 is a top down view of the backing-up mechanism;

FIG. 15 is an enlargement of the chain switch;

FIG. 16 is a top-down view of the cranking movement of the handlebars;

FIG. 17 is a front view of the steering movement of the handlebars;

FIG. 18 is a perspective rendered view of the handlebars with a swivel feature; and

FIG. 19 is a front view of a simpler embodiment that can replace the bottom-bracket-cassette torque transmitting device.

### DETAILED DESCRIPTION OF PREFERRED EMBODIMENTS

When describing the present invention, all terms not defined herein have their common art recognized meanings. The term driving is defined as providing power. The term steering is defined as providing direction. The term unidirectional is used to describe devices that have an operation or motion in one direction only. The term opposing is used to describe a device that operates in a direction that is opposite another device's operation about a common axis or pivot. The term ratchet is used to describe any device consisting of a pawl and or a roller and or a sprag that engages the sloping teeth of a wheel and or bar and or an inclined cam, permitting motion in one direction only. The term freewheel is used to describe any device that disengages a drive shaft from the driven shaft in the case that the driven shaft would rotate at a higher rate than the drive shaft. The term overrunning clutch is used to describe any device that permits a rotating member to turn freely under some conditions but not under other conditions

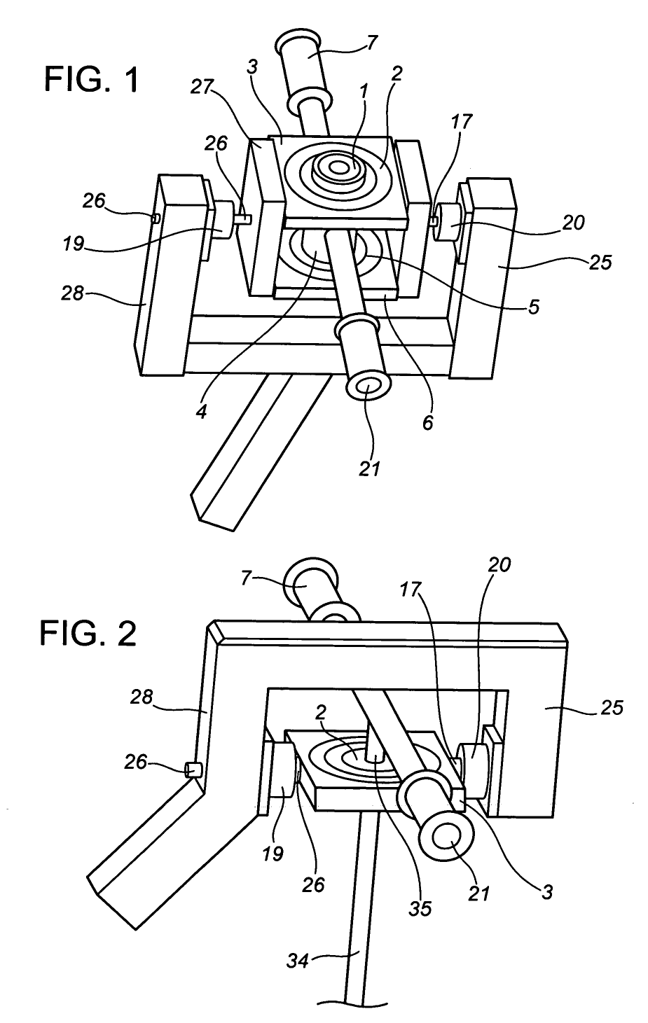

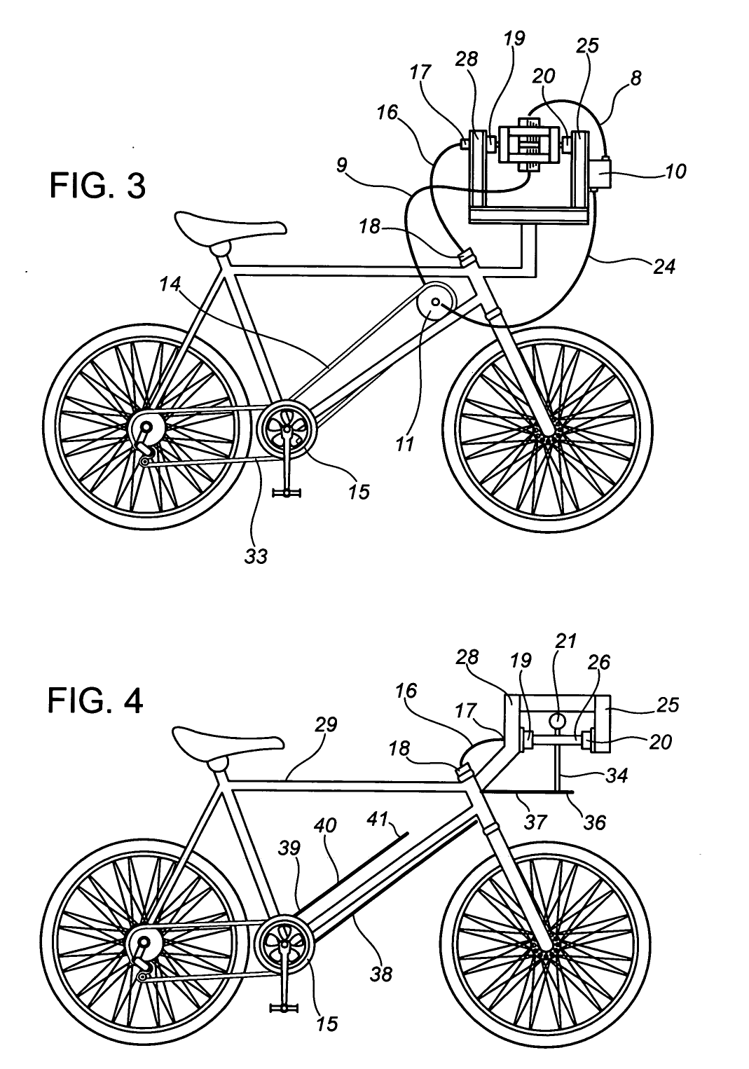

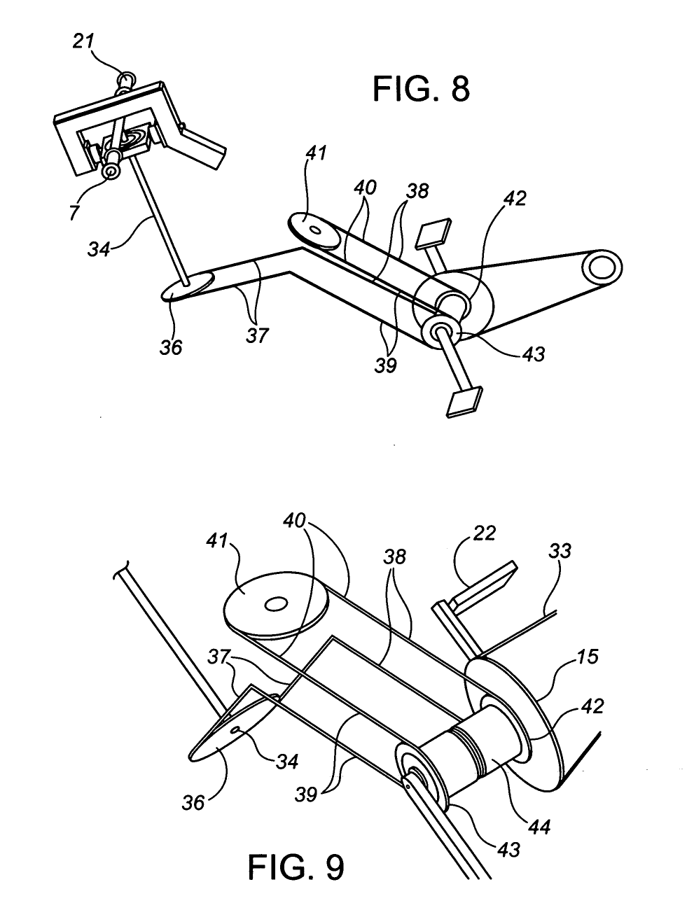

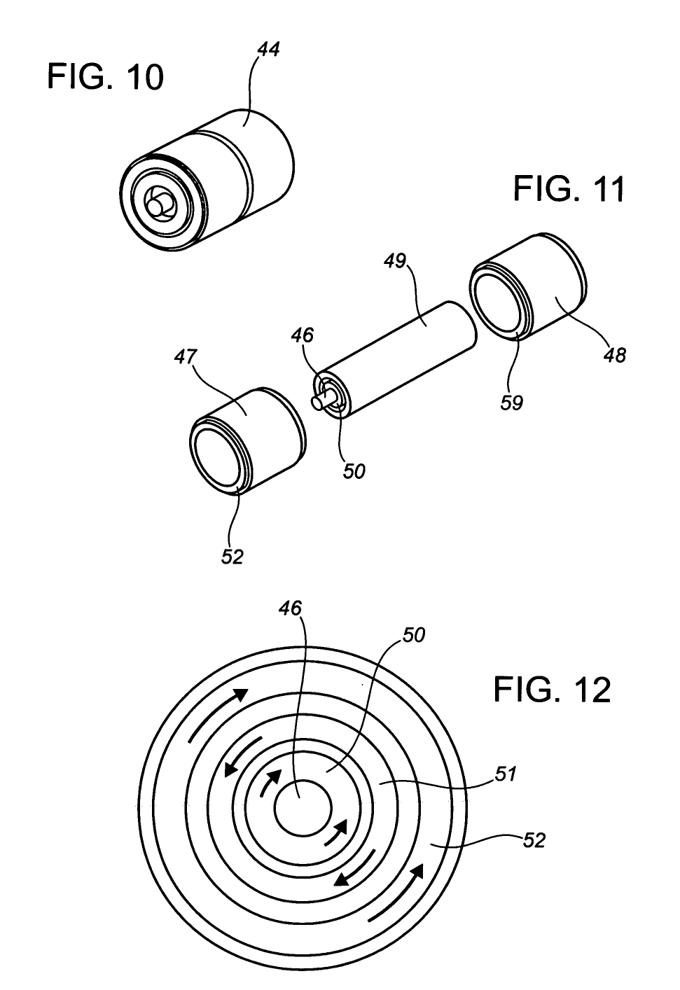

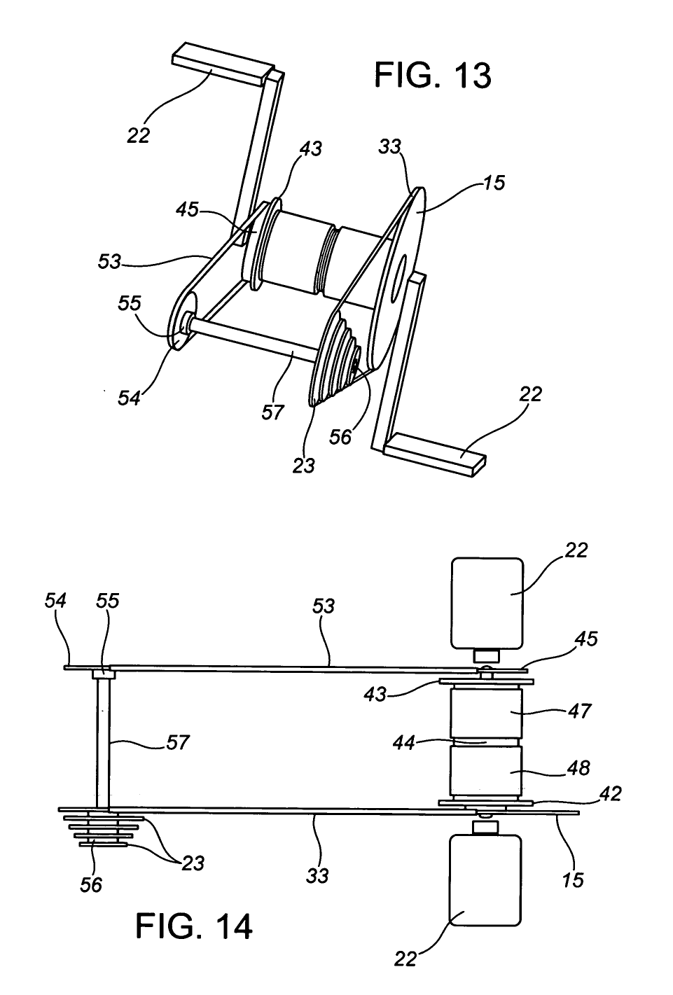

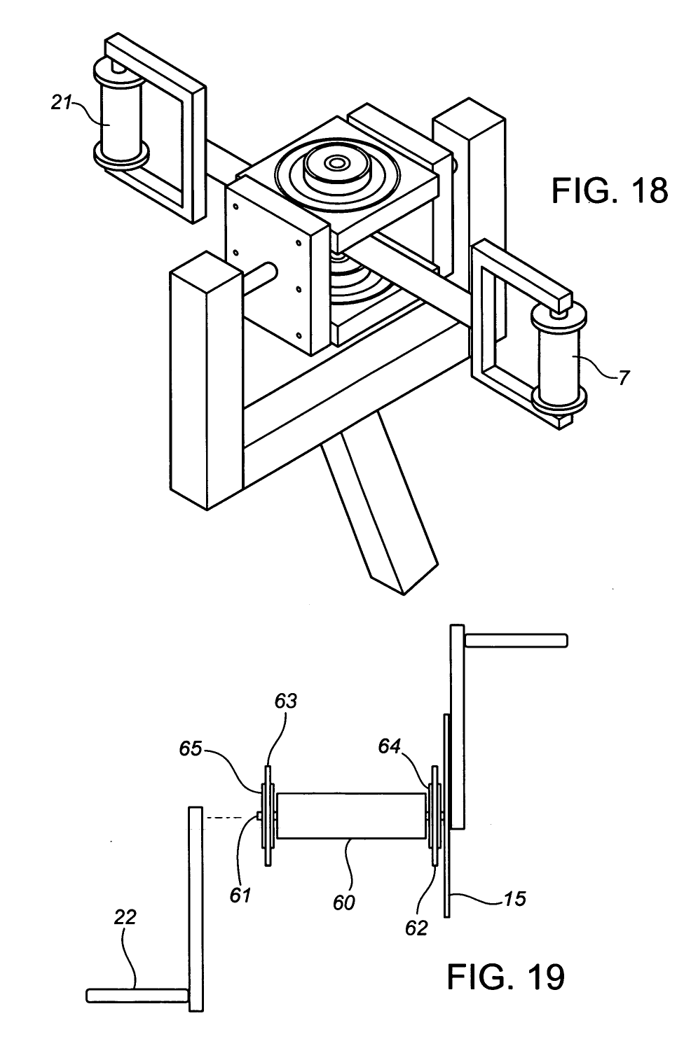

The present invention provides for a device for driving and steering an operator powered vehicle. FIG. 1 and FIG. 2 illustrate two examples of handlebars in support frames for a bicycle as shown in FIG. 3 and FIG. 4, respectively. FIG. 17 and FIG. 18 illustrate the motion of the handlebars. The driving power generated by the motion of the handlebars provide auxiliary power to the foot pedal axis of bicycle through a cassette comprising three ratchet type devices illustrated in FIGS. 10-12. A simpler version of said cassette embodiment is illustrated in FIG. 19. The driving power generated by the motion of the handlebars is transmitted to the cassette comprising three ratchet type devices by a chain disposed between two auxiliary sprockets, illustrated by FIG. 8 and FIG. 9. An optional backing up mechanism for the bicycle is illustrated in FIG. 13 and FIG. 14.

As shown in FIG. 1 and FIG. 3 the front end of a conventional bicycle frame (29) is shown having a U-shaped frame with a front vertical member (25) and a back vertical member (28) in the place of conventional steering column and handlebars. Front steering shaft (17) is rotably connected at one end to the front vertical member (25) of the U-shaped frame through front steering bearing and pillow (20) and rigidly connected at the other end to the front of handlebar support structure (27). Back steering shaft (26) is rotably connected at one end to the back vertical member of the U-shaped frame (28) through back steering bearing and pillow (26) and rigidly connected at the other end to the back of handlebar support structure (27). Left handlebar (7) and right handlebar (21) are connected to a top counter clockwise overrunning clutch (1) and bottom clockwise overrunning clutch (4). The top counter clockwise overrunning clutch (1) is supported by the top face of handlebar support structure (27) and the bottom clockwise overrunning clutch (4) is supported by the bottom face of handlebar support structure (27). The top counter clockwise overrunning clutch (1) and the bottom clockwise overrunning clutch (4) are oriented to allow the left handlebar (7) and right handlebar (21) to move forward and back about a pivot along a substantially vertical axis. Handlebar support structure (27) is shaped as a rectangular or square box having a solid face suitable for a rigid connection to the steering shafts (17) (26), an open left and right side to allow for forward and back motion of left handlebar (7) and right handlebar (21) and a partially open top and bottom face to support the top counter clockwise overrunning clutch (1) and the bottom clockwise overrunning clutch (4).

A bi-directional flexible shaft (16) connects the back steering shaft (26) to the bottom steering shaft (18).

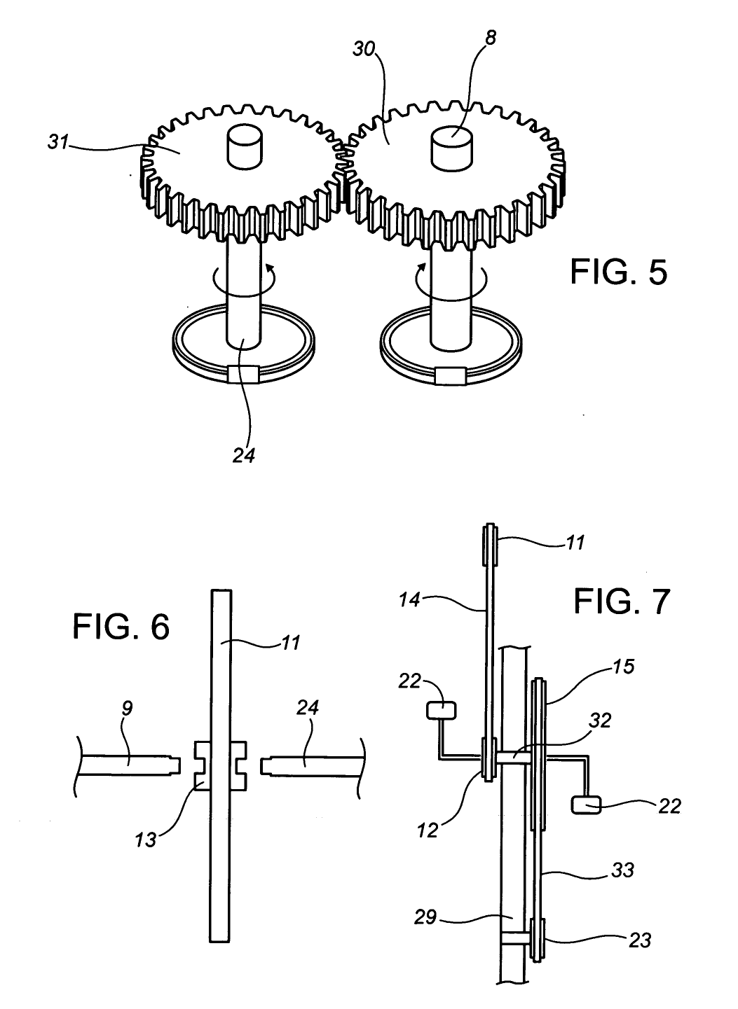

As shown in FIG. 3 and FIG. 5 a gearbox (10) is attached to the front vertical member of the U-shaped frame (25). A top uni-directional flexible shaft (8) connects top counter clockwise overrunning clutch (1) to first gear (30), which is supported inside gearbox (10). The teeth of first gear (30) are operationally disposed between the teeth of second gear (31), which is also supported inside gearbox (10).

As shown in FIG. 3 and FIG. 6 an auxiliary sprocket (11) having a centrally disposed auxiliary overrunning clutch (13) is supported by a conventional bicycle frame (29). A bottom uni-directional flexible shaft (9) connects the bottom clockwise overrunning clutch (4) to the left side of auxiliary overrunning clutch (13). A uni-directional flexible shaft (24) connects second gear (31) to the right side of auxiliary overrunning clutch (13).

As shown in FIG. 3 and FIG. 7 an auxiliary sprocket (12) and a main sprocket (15) and foot pedals (22) are attached to the foot pedal axis (32) of a conventional bicycle frame (29). Rear sprockets (23) drive the rear wheel of a conventional bicycle. An auxiliary chain (14) connects auxiliary sprocket (11) to auxiliary sprocket (12). Main chain (33) connects main sprocket (15) to rear sprocket (23). The auxiliary sprocket (11) having a centrally disposed auxiliary overrunning clutch (13), the chain drive (14) and the auxiliary sprocket (12) could be dispensed of by the direct co-axially connection of the uni-directional flexible shaft (24) and uni-directional flexible shaft (9) to the main front sprocket shaft through bevel gears and having means to overrun when necessary.

The operator may power the bicycle (29) independently by conventional rotation of the foot pedals (22) or by rotation of the handlebars (7) (21).

When handlebar (7) is pushed forward and handlebar (21) is pulled back torque is imparted to the overrunning clutch (1). The torque from the overrunning clutch (1) is transferred by top unidirectional flexible shaft (8) to gearbox (10) where gears (30) and (31) reverse the direction of the torque. The reversed torque is transferred by uni-directional flexible shaft (24) to auxiliary overrunning clutch (13) to auxiliary sprocket (11) to auxiliary chain (14) to auxiliary sprocket (12) to foot pedal axis (32) to main front sprocket (15) to main chain (33) to rear sprocket (23) driving the rear wheel. Through auxiliary overrunning clutch (13) torque is also transferred to bottom uni-directional flexible shaft (9) to bottom clockwise overrunning clutch (4) to end freewheeling.

When handlebar (7) is pulled back and handlebar (21) is pushed forward torque is passed to bottom clockwise overrunning clutch (4) to bottom uni-directional flexible shaft (9) to auxiliary sprocket (11) to auxiliary chain (14) to auxiliary sprocket (12) to foot pedal axis (32) to main front sprocket (15) to main chain (33) to rear sprocket (23) driving the rear wheel. Through auxiliary overrunning clutch (13) torque is also transferred to unidirectional flexible shaft (24) to gearbox (10) where gears (31) and (30) reverse the torque which is transferred by top uni-directional flexible shaft (8) to top counter clockwise overrunning clutch (1) where to end freewheeling.

When foot pedals (22) are operated on, torque is passed to main front sprocket (15) to main chain (33) to rear sprocket (23) driving the rear wheel, as well as to foot pedal axis (32) to auxiliary sprocket (12) to auxiliary chain (14) to auxiliary sprocket (11) to auxiliary overrunning clutch (13) where it ends freewheeling.

When the optional backing-up mechanism is installed and the foot pedals (22) are operated on forwards, torque is imparted to the axle of the foot pedal axis (32), then to backing-up front sprocket (45), then to backing-up chain drive (53) then to backing-up rear sprocket (54), which overruns (freewheels) because of the overrunning qualities of the reversed rear hub left freewheel (55). An overrunning clutch could replace the reversed rear hub left freewheel (55) for silent operation.

When the optional backing-up mechanism is installed, and the foot pedals (22) are operated on backwards, torque is imparted to the axle of the foot pedal axis (32), then to backing-up front sprocket (45) then to backing-up chain drive (53) then to backing-up rear sprocket (54) driving the rear wheel, allowing the vehicle to be operated backing-up, important to vehicles that behave like automobiles, like 3 or 4 wheelers. From this invention conventional bicycles can be fitted or retrofitted with the backing-up mechanism.

When handlebars (7) and (21) are moved up or down, rotating about the steering axis defined by front steering shaft (17) and back steering shaft (26) torque is transmitted by bi-directional flexible shaft (16) to bottom steering shaft (18) which turns the front wheel of the bicycle left and right.

As shown in FIG. 2 and FIG. 4 the front end of a conventional bicycle frame (29) is shown having a U-shaped frame with a front vertical member (25) and a back vertical member (28) in the place of conventional steering column and handlebars. Front steering shaft (17) is rotably connected at one end to the front vertical member of the U-shaped frame (25) through front steering bearing and pillow (20) and rigidly connected at the other end to the front of pillow bearing (3). Back steering shaft (26) is rotably connected at one end to the back vertical member of the U-shaped frame (28) through back steering bearing and pillow (26) and rigidly connected at the other end to the back of pillow bearing (3). Left handlebar (7) and right handlebar (21) are connected rigidly to the handlebars crank shaft (35) which in turn is connected to one end of the bottom bi-directional flexible shaft (34), the other end of the bottom bi-directional flexible shaft (34) is connected to the idle torque sprocket (36) with means to rotate both ways and means to be mounted on frame of said vehicle. The top bearing (2) is oriented to allow the left handlebar (7) and right handlebar (21) to move forward and back about a pivot along substantially vertical axis. Pillow bearing (3) is shaped as a rectangular or square shape having a solid face suitable for a rigid connection to the steering shafts (17) (26).

A bi-directional flexible shaft (16) connects the back steering shaft (26) to the bottom steering shaft (18).

As shown in FIG. 4, FIG. 8 and FIG. 9 and FIG. 19 a vertical, as to its width, oriented chain A (37) wraps around torque sprocket (36), which is also vertical oriented, to link on the right side (from FIG. 8 and FIG. 9 perspective view) to the horizontal oriented chain D (38) which in turn wraps around from its bottom and in a counter clockwise fashion of the right bottom-bracket-cassette sprocket (42) or right ratchet device sprocket (62) coming from the top to link to the vertical oriented chain C (40) which in turn wraps around the somewhat horizontal oriented idle sprocket (41) to link to the horizontal oriented chain B (39) which in turn wraps around from its top and in a clockwise fashion of the left bottom-bracket-cassette sprocket (43) or left ratchet device sprocket (63) coming from below to end up linking to the vertical oriented chain A (37), and vice versa, thus forming a circuit of a finite nature. Chain A (37) and chain B (39) and chain C (40) and chain D (38) are given the necessary length to allow for the rotation of sprockets (36), (43) or (63), (42) or (62) and (41) without reaching the chain links (58).

As shown in FIG. 10 and FIG. 11 and FIG. 14 a bottom-bracket crank axle (46) is disposed inside an inner overrunning clutch (49) which in turn is disposed inside two, a left bottom-bracket overrunning clutch (47) and a right bottom-bracket overrunning clutch (48), both in a counter clockwise fashion with respect to the inner overrunning clutch (49), thus forming the bottom-bracket-cassette (44) which is disposed inside the bottom-bracket shell (32). The left bottom-bracket-cassette sprocket (43) is fastened to member E1 (52) of left outer overrunning clutch (47) and actuated by chain B (39), the right bottom-bracket-cassette sprocket (42) is fastened to member E2 (59) of right outer overrunning clutch (48) and actuated by chin D (38), the main front sprocket (15) is fastened on the side customarily of bicycles of member C of inner overrunning clutch (49) and actuated by the main chain drive (33) which in turn is actuated by the bottom-bracket-cassette axle (46) and in turn by the foot pedals (22). In like manner and replacing the bottom-bracket-cassette embodiment with the version from FIG. 19, the left ratchet device sprocket (63) is fastened to the conventional bicycle bottom bracket axle (61) and actuated by chain B (39), the right ratchet device sprocket (62) is fastened to the conventional bicycle bottom bracket axle (61) and actuated by chain D (38), the main front sprocket (15) is fastened on the side customarily of bicycles of the conventional bicycle bottom bracket axle (61) and actuated by the main chain drive (33) which in turn is actuated by the conventional bicycle bottom bracket axle (61) and in turn by the foot pedals (22).

As shown in FIG. 12 a cross section from the left side, where the main front sprocket (15) is not attached, of the bottom-bracket-cassette (44) is shown where member A (50) of inner overrunning clutch (49) has a clockwise overrunning direction and a counter clockwise driving direction, member C (51) of the inner overrunning clutch (49) has a counter clockwise overrunning direction and a clockwise driving direction, member E1 (52) of left outer overrunning clutch (47) and member E2 (59) of right outer overrunning clutch (48) have a clockwise overrunning direction and a counter clockwise driving direction, and vice versa.

As shown in FIG. 13 and FIG. 14 the backing-up mechanism consists of backing-up front sprocket (45), which is fastened to the left side of the bottom-bracket-cassette axle (46), which drives backing-up chain drive (53) connected to backing-up rear sprocket (54) fitted with a reversed rear hub left freewheel (55) attached to the rear hub axle (57).

From the above design one can see that the simpler embodiment illustrated by FIG. 19 is accomplished by mounting sprockets (62) and (63) on ratchet devices (64) (65) and in turn mounting them on the axle of a standard bottom-bracket bicycle (61), which axle has been lengthened to accommodate them; however, two minor inconveniences would occur: when handlebars are activated without the pedals being done so, the pedals will still turn, and backing up would only be accomplished if both pedals and handlebars are set in motion together.

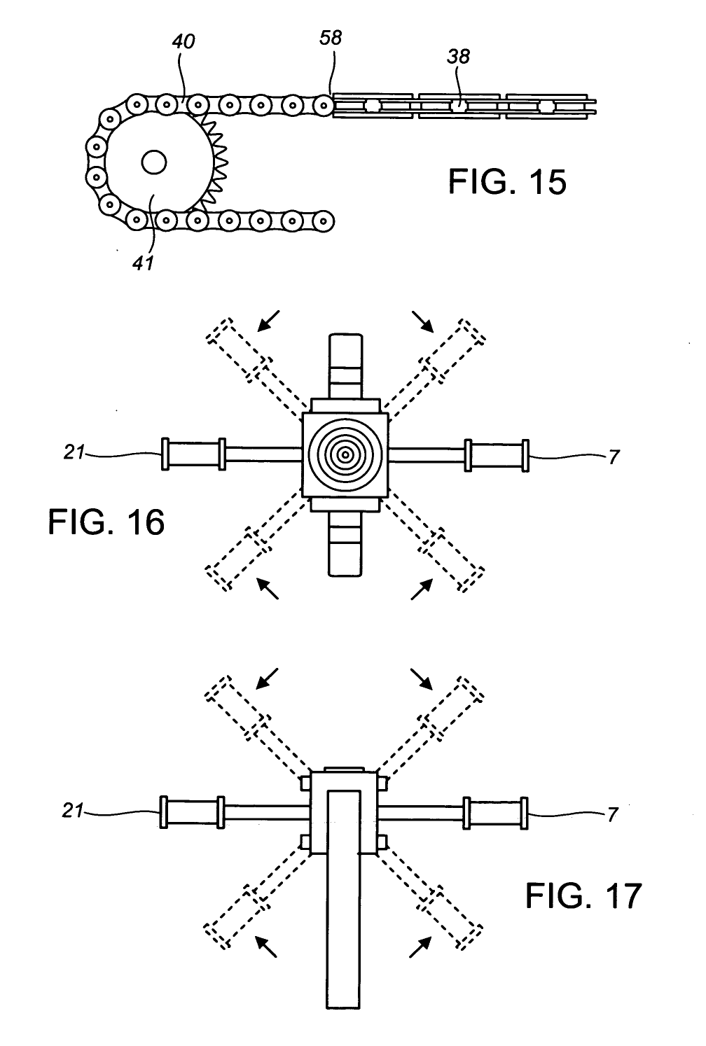

As shown in FIG. 15 from a top down view an idle sprocket (41) is actuated by chain C (40) having the means to be linked (58) to chain D (38) from a vertical plane, which allows the actuation of the somewhat horizontally disposed idle sprocket (41) to a horizontal plane, which allows the actuation of the right bottom-bracket-cassette sprocket (42) or the right ratchet device sprocket (62) (not shown).

When handlebar (7) is pushed forward and handlebar (21) is pulled back torque is imparted through the handlebars cranking shaft (35) to the bottom bi-directional flexible shaft (34), which in turn imparts clockwise torque to the torque sprocket (36), which in turn transfers power to chain A (37), then to chain D (38), which wraps around from its bottom of the right bottom-bracket-cassette sprocket (42) to link to chain C (40), which wraps counter clockwise around idle sprocket (41), which idles, to link to chain B (39), which wraps around form its top to the left bottom-bracket-cassette sprocket (43), which freewheels because is attached to member E1 (52) of left outer overrunning clutch (47), which is in an overrunning direction, then chain B (39) coming from the bottom of left bottom-bracket-cassette sprocket (43) links to chain A (37) ending the circuit. As chain D (38) wraps around from its bottom of right bottom-bracket-cassette sprocket (42) it imparts torque to it, which in turn imparts torque to member E2 (59) of right outer overrunning clutch (48), which is in driving direction, causing to impart torque to member C (51) of inner overrunning clutch (49), which is in its overrunning direction, but since it is not actuated directly, it behaves in a driving direction imparting torque to the main front sprocket (15) to main chain drive (33) to rear sprocket (23) driving the rear wheel. Flexible shaft (34) should have enough slack to allow the swivel of the handles when steering. Although member C (51) of inner overrunning clutch (49) is indirectly caused to impart torque to the main front sprocket (15), its relation to member A (50) of the inner overrunning clutch (49) remains true and does not impart torque to it, and therefore neither to the bottom-bracket-cassette axle (46) and the foot pedals (22) allowing the vehicle to be powered independently of the conventional foot torque.

When handlebar (7) is pulled back and handlebar (21) is pushed forward torque is imparted through the handlebars cranking shaft (35) to the bottom bi-directional flexible shaft (34), which in turn imparts counter clockwise torque to the torque sprocket (36), which in turn transfers power to chain A (37), then to chain B (39), which wraps around from its bottom of the left bottom-bracket-cassette sprocket (43) to link to chain C (40), which wraps clockwise around idle sprocket (41), which idles, to link to chain D (38), which wraps around from its top to the right bottom-bracket-cassette sprocket (42), which freewheels because is attached to member E2 (59), which is in an overrunning direction, then chain D (38) coming from the bottom of right bottom-bracket-cassette sprocket (42) links to chain A (37) ending the circuit. As chain B (39) wraps around from its bottom of left bottom-bracket-cassette sprocket (43) it imparts torque to it, which in turn imparts torque to member E1 (52) of left outer overrunning clutch (47), which is in driving direction, causing to impart torque to member C (51) of inner overrunning clutch (49), which is in its overrunning direction, but since it is not actuated directly, it behaves in a driving direction imparting torque to the main front sprocket (15) to main chain drive (33) to rear sprocket (23) driving the rear wheel. Although member C (51) of inner overrunning clutch (49) is indirectly caused to impart torque to the main front sprocket (15), its relation to member A (50) of the inner overrunning clutch (49) remains true and does not impart torque to it, and therefore neither to the bottom-bracket-cassette axle (46) and the foot pedals (22) allowing the vehicle to be powered independently of the conventional foot torque.

When foot pedals (22) are operated on forwards, torque is passed to bottom-bracket-cassette axle (46) then to member A (50) of inner overrunning clutch (49), which is in driving direction, then to member C (51) of inner overrunning clutch (49), which is in overrunning direction, but since member C (51) is not actuated directly, it behaves in a driving direction imparting torque to the main front sprocket (15) to main chain drive (33) to rear sprocket (23) driving the rear wheel. Although member C (51) is indirectly caused to impart torque to the main front sprocket (15), its relation to member E1 (52) of the left outer overrunning clutch (47) and member E2 (59) of the right outer overrunning clutch (48) remains true and does not impart torque to them, and therefore neither to the left and right bottom-bracket-cassette sprockets (42) (43) allowing the vehicle to be powered independently of the handlebars torque.

When foot pedals (22) are operated on backwards, torque is passed to the bottom-bracket-cassette axle (46) then to member A (50) of inner overrunning clutch (49), which overruns (freewheels) because is in an overrunning direction, allowing the vehicle to coast.

When foot pedals (22) are not operated on while in motion, the vehicle coasts because of the overrunning qualities of the right rear hub freewheel (56).

When the optional backing-up mechanism is installed and the foot pedals (22) are operated on forwards, torque is imparted to the bottom-bracket-cassette axle (46), then to backing-up front sprocket (45), then to backing-up chain drive (53) then to backing-up rear sprocket (54), which overruns (freewheels) because of the overrunning qualities of the reversed rear hub left freewheel (55). An overrunning clutch could replace the reversed rear hub left freewheel (55) for silent operation.

When the optional backing-up mechanism is installed, and the foot pedals (22) are operated on backwards, torque is imparted to the bottom-bracket-cassette axle (46) then to backing-up front sprocket (45) then to backing-up chain drive (53) then to backing-up rear sprocket (54) driving the rear wheel, allowing the vehicle to be operated backing-up, important to vehicles that behave like automobiles, like 3 or 4 wheelers. It is also understood that a backing-up feature will serve also as an emergency and add-on brake system, adding to the safety of the invention.

In the above descriptions, terms such as left, right, top, bottom and the like are used solely for the purpose of clarity in illustrating the invention, and should not be taken as words of limitation. Aspects like streamlining, for example, making overrunning clutches and pillow bearings and bearings one piece rather than three, have not been considered for they are not needed to illustrate the concept of the invention. Furthermore, chain line, shock momentum, and other efficiency details have been left aside for they could be dealt in many forms, such as enlarging the wheelbase of the vehicle, the use of chainless hub technology, improved overrunning clutches technology and so on.

Those skilled in the art can appreciate that the specific embodiment of a bicycle disclosed herein may be readily utilized as a basis for modifying other vehicles without departing from the spirit and scope. For example, operator powered vehicles may include cycles having one to four wheels, exercise equipment, wheel chairs, personal watercraft, having at least one operator or two to four operators in tandem, that may be positioned conventionally or in a recumbent manner, elements could also be made from diverse materials.

Furthermore, existing technology such as chain, gears, chainless hubs, universal joints can be relatively easily arranged to accommodate the different relative locations of steering elements, such as front wheels and rudders, and drive elements, such as rear wheels and propellers. In general the invention can be used with any type of human powered vehicle having a drive that includes a rotatable front sprocket or shaft used to transmit torque to wheel(s) or propeller(s) or in anyone of several established manners, such as gears, belts or chains.

### LIST OF REFERENCE NUMERALS

1—Top counter clockwise overrunning clutch
2—Top bearing
3—Top pillow bearing
4—Bottom clockwise overrunning clutch
5—Bottom bearing
6—Bottom pillow bearing
7—Left handlebar
8—Top unidirectional flexible shaft
9—Bottom uni-directional flexible shaft
10—Gearbox
11—Auxiliary sprocket
12—Auxiliary chain
13—Auxiliary overrunning clutch
14—Auxiliary chain
15—Main front sprocket
16—Bi-directional flexible shaft
17—front steering shaft
18—Bottom steering shaft
19—Back steering bearing and pillow
20—Front steering bearing and pillow
21—Right handlebar
22—Foot pedal
23—Rear sprockets
24—Uni-directional flexible shaft
25—Front vertical member of the U-shaped frame
26—Back steering shaft
27—Handlebar support structure
28—Back vertical member of the U-shaped frame
29—Conventional bicycle frame
30—First gear
31—Second gear
32—Foot pedal axis (bottom-bracket shell)
33—Main chain drive
34—Bottom bidirectional flexible shaft
35—Handlebars cranking shaft
36—Torque sprocket
37—Chain A
38—Chain D
39—Chain B
40—Chain C
41—Idle sprocket
42—Right bottom-bracket-cassette sprocket
43—Left bottom-bracket-cassette sprocket
44—Bottom-bracket-cassette
45—Backing-Up front sprocket
46—Bottom-bracket cassette axle
47—Left outer overrunning clutch
48—Right outer overrunning clutch
49—Inner overrunning clutch
50—Member A of inner overrunning clutch
51—Member C of inner overrunning clutch
52—Member E1 of left outer overrunning clutch
53—Backing-up chain drive
54—Backing-up rear sprocket
55—Reversed rear hub left freewheel
56—Right rear hub freewheel
57—Rear hub axle
58—Chain link
59—Member E2 of right outer overrunning clutch
60—Conventional bicycle bottom bracket
61—Conventional bicycle bottom bracket axle
62—Right ratchet device sprocket
63—Left ratchet device sprocket
64—Right ratchet device
65—Left ratchet device

What is claimed is:

1. A device for driving and steering an operator powered vehicle, said device comprising:
(a) a support frame; and
(b) a handlebar attached to the support frame by drive actuation means and by steering actuation means;
wherein said drive actuation means comprises a driving shaft or ratchet mechanism operating connected to a vehicle drive wheel, wherein reciprocating rotational movement of the handlebar about a drive pivot axis actuates the driving shaft or ratchet mechanism,
wherein said steering actuation means comprises a steering shaft connected to a vehicle wheel, wherein reciprocating rotational movement of the handlebar about a steering axis actuates the steering shaft,
wherein the drive pivot axis and the steering axis are substantially perpendicular to each other.

2. The device of claim 1 in which the drive actuation means comprises a driving shaft centrally disposed about the driving pivot.

3. The device of claim 2 further comprising a bi-directional flexible shaft, having a first end and a second end, wherein the first end is attached at to the driving shaft and at the second end is attached to a transmitting torque gear.

4. The device of claim 1 in which the drive actuation means comprises a first ratchet type device and a second opposing ratchet type device centrally disposed about the driving pivot.

5. The device of claim 4 in which the drive actuation means further comprises a first uni-directional flexible shaft attached to the first ratchet type device and a second uni-directional flexible shaft attached to the second ratchet type device.

6. The device of claim 5 in which the uni-directional flexible shaft attached to the second ratchet type device is further attached to first gear having a first set of teeth, said first set of teeth rotably disposed between the second set of teeth of a second gear, said second gear attached to a third unidirectional flexible shaft, wherein the torque of the third uni-directional flexible shaft is in the opposite direction of the torque of the second uni-directional flexible shaft.

7. The device of claim 1 in which the steering actuation means comprises a steering shaft.

8. The device of claim 7 further comprising a bi-directional flexible shaft attached at to one end to the steering shaft and at the other end to the steering column of a vehicle.

9. The device of claims 1-8 in which the operator powered vehicle is a bicycle.

10. A device for transmitting torque comprising:
(a) a support frame;
(b) an axle, supported on the frame, defining an axis about which the axle is rotable, having a left and right end, disposed inside and engaging an inner ratchet member such that the torque from the rotating axle is imparted directly, maintaining the direction of the torque, to the inner ratchet member;
(c) an inner ratchet member rotable about the axle, disposed inside and engaging a middle ratchet member, over-running in counter-clockwise direction, driving in clockwise direction such that torque from inner ratchet member is imparted indirectly, reversing the direction of the torque, to the middle ratchet member;
(d) a middle ratchet member disposed inside a pair of opposing outer ratchet members comprising a right outer ratchet member and a left outer ratchet member, rotable about the axle, over-running in a clock wise direction and driving in the counter clockwise direction;
(e) a right outer ratchet member rotable about the axle, over-running in a clockwise direction and driving in a counter clockwise direction engaging and imparting torque directly, maintaining the direction of the torque, to the inner ratchet member; and
(f) a left outer ratchet member rotable about the axle, over-running in a clockwise direction and driving in a counter clockwise direction engaging and imparting torque directly, maintaining the direction of the torque, to the inner ratchet member.

11. The device for transmitting torque according to claim 10, wherein a left foot-pedal is attached to the left end of the axle and a right foot-pedal is attached to the right end of the axle.

12. The device for transmitting torque according to claim 10 or 11 wherein a front sprocket is disposed to rotate about the axle and is engaged by the inner ratchet member such that torque from the inner ratchet member is indirectly transferred, reversing torque at front sprocket.

13. The device for transmitting torque of claims 10-12 further comprising:
(a) a first and a second auxiliary sprocket supported by the frame; and
(b) single circular chain disposed between and engaging the first auxiliary sprocket and the second auxiliary sprocket defining a left side of the chain and a right side of the chain, the left side of the chain partially wrapping around and directly engaging the left outer ratchet member and the right side of the chain partially wrapping around and directly engaging the right outer ratchet member.

14. The device for transmitting torque of claim 13 further comprising:
(a) a handlebar attached to the support frame by drive actuation means and by steering actuation means;
wherein said drive actuation means comprises a shaft operating connected to a vehicle drive wheel, wherein reciprocating rotational movement of the handlebar about a drive pivot axis actuates the shaft.
wherein said steering actuation means comprises a flexible shaft connected to a vehicle wheel, wherein reciprocating rotational movement of the handlebar about a steering axis actuates the flexible shaft,
wherein the drive pivot axis and the steering axis are substantially perpendicular to each other.

15. The device of claim 14 in which the drive actuation means comprises a driving shaft centrally disposed about the driving pivot.

16. The device of claim 15 further comprising a bidirectional flexible shaft having a first end and a second end, wherein the first end is attached at to the driving shaft and at the second end is attached to a transmitting torque gear.

17. The device for transmitting torque according to claim 14, wherein a left foot-pedal is attached to the left end of the axle and a right foot-pedal is attached to the right end of the axle.

18. The device for transmitting torque according to claim 16 or 17 wherein a front sprocket is disposed to rotate about the axle engaged by the inner ratchet member such that torque from the inner ratchet member is indirectly transferred, reversing torque at front sprocket.

19. The device for transmitting torque according to claim 18 wherein a rear wheel having a rear wheel sprocket is rotably supported by the frame and a single circular chain is disposed between and engaging the front sprocket and rear wheel sprocket.

20. The device for transmitting torque according to claim 19 wherein the rear wheel sprocket is further mounted on a ratchet device, and a single circular chain is disposed between and engaging the auxiliary front sprocket and rear wheel sprocket.

21. The device of claim 14 in which the drive actuation means comprises a first ratchet type device and a second opposing ratchet type device centrally disposed about the driving pivot.

22. The device of claim 21 in which the drive actuation means further comprises a first unidirectional flexible shaft attached to the first ratchet type device and a second uni-directional flexible shaft attached to the second ratchet type device.

23. The device of claim 22 in which the uni-directional flexible shaft attached to the second ratchet type device is further attached to a first gear having a first set of teeth, said first set of teeth rotably disposed between the second set of teeth of a second gear, said second gear attached to a third uni-directional flexible shaft, wherein the torque of the third unidirectional flexible shaft is in the opposite direction of the torque of the second uni-directional flexible shaft.

24. The device of claim 14 in which the steering actuation means comprises a steering shaft.

25. The device of claim 24 further comprising a bi-directional flexible shaft attached at to one end to the steering shaft and at the other end to the steering column of a vehicle.

26. The device for transmitting torque according to claims 21-25 wherein a left foot-pedal is attached to the left end of the axle and a right foot-pedal is attached to the right end of the axle.

27. The device for transmitting torque according to claim 26 wherein a front sprocket is disposed to rotate about the axle engaged by a ratchet member wherein the torque from the ratchet member is directly transferred to the front sprocket.

28. The device for transmitting torque according to claim 27 wherein a rear wheel having a rear wheel sprocket is rotably supported by the frame and a single circular chain is disposed between and engaging the front sprocket and rear wheel sprocket.

29. The device for transmitting torque according to claim 23 wherein the first ratchet type device is the first side of the first auxiliary sprocket and the third uni-directional flexible shaft is attached to the second side of the first auxiliary sprocket.

30. A device for transmitting torque comprising:
(a) a support frame;
(b) a bottom bracket supported on the frame, having an axle defining an axis about which the axle is rotable, having a left and right end;
(c) a right outer ratchet member rotable and disposed about the axle, over-running in a counter clockwise direction and driving in a clockwise direction engaging and imparting torque directly, maintaining the direction of the torque, to the axle; and
(d) a left outer ratchet member rotable and disposed about the axle, over-running in a counter clockwise direction and driving in a clockwise direction engaging and imparting torque directly, maintaining the direction of the torque, to the axle.

31. The device for transmitting torque of claim 30 further comprising:
(a) a first and a second auxiliary sprocket supported by the frame; and
(b) single circular chain disposed between and engaging the first auxiliary sprocket and the second auxiliary sprocket defining a left side of the chain and a right side of the chain, the left side of the chain partially wrapping around and directly engaging the left outer ratchet member and the right side of the chain partially wrapping around and directly engaging the right outer ratchet member.

32. The device for transmitting torque of claim 31 further comprising:
(a) A handlebar attached to the support frame by drive actuation means and by steering actuation means;
wherein said drive actuation means comprises a shaft operating connected to a vehicle drive wheel, wherein reciprocating rotational movement of the handlebar about a drive pivot axis actuates the shaft.
wherein said steering actuation means comprises a flexible shaft connected to a vehicle wheel, wherein reciprocating rotational movement of the handlebar about a steering axis actuates the flexible shaft,
wherein the drive pivot axis and the steering axis are substantially perpendicular to each other.

33. The device of claim 32 in which the drive actuation means comprises a driving shaft centrally disposed about the driving pivot.

34. The device of claim 33 further comprising a bi-directional flexible shaft having a first end and a second end, wherein the first end is attached at to the driving shaft and at the second end is attached to a transmitting torque gear.

35. The device for transmitting torque according to claim 32, wherein a left foot-pedal is attached to the left end of the axle and a right foot-pedal is attached to the right end of the axle.

36. The device for transmitting torque according to claim 32 or 33 wherein a front sprocket is disposed to rotate about the axle engaged by a ratchet member such that torque from the ratchet member is directly transferred to said front sprocket.

37. The device for transmitting torque according to claim 36 wherein a rear wheel having a rear wheel sprocket is rotably supported by the frame and a single circular chain is disposed between and engaging the front sprocket and rear wheel sprocket.

38. The device for transmitting torque in reverse according to claim 37 wherein a rear wheel having a rear wheel sprocket mounted on a ratchet device is rotably supported by the frame and a single circular chain is disposed between and engaging the auxiliary front sprocket and rear wheel sprocket.
